(19) United States
(12) Patent Application Publication
(10) Pub. No.: US 2025/0184844 A1
(43) Pub. Date: Jun. 5, 2025

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/048,400

(22) Filed: Feb. 7, 2025

Related U.S. Application Data
(63) Continuation of application No. PCT/JP2023/028765, filed on Aug. 7, 2023.
(60) Provisional application No. 63/395,944, filed on Aug. 8, 2022.

(51) Int. Cl. H04W 36/08; H04W 76/10; H04W 88/04

(52) U.S. Cl. CPC H04W 36/08; H04W 76/10; H04W 88/04

(57) ABSTRACT

A communication control method according to one aspect is a communication control method used in a cellular communication system. The communication control method includes transmitting, at a mobile relay node configured to migrate from a source donor node to a target donor node, an F1 setup request message for requesting establishment of F1 connection to the target donor node in response to reception of a predetermined message from the source donor node. Here, the predetermined message is a message representing one of a new establishment request of F1 connection for the target donor node and a migration indication to the target donor node.

### RELATED APPLICATIONS

The present application is a continuation based on PCT Application No. PCT/JP2023/028765, filed on Aug. 7, 2023, which claims the benefit of U.S. Provisional Patent Application No. 63/395,944 filed on Aug. 8, 2022. The content of which is incorporated by reference herein in their entirety.

### TECHNICAL FIELD

The present disclosure relates to a communication control method used in a cellular communication system.

### BACKGROUND

The Third Generation Partnership Project (3GPP) that is a standardization project of a cellular communication system has studied introduction of a new relay node referred to as an Integrated Access and Backhaul (IAB) node (see, for example, Non-Patent Document 1). One or more relay nodes are involved in communication between a base station and a user equipment and perform relay for this communication.

According to NR of 3GPP, an aggregation node constituting a gNB is defined as a Central Unit (CU), and a distributed node constituting the gNB is defined as a Distributed Unit (DU). A PDCP layer and upper layers are installed in the CU, an RLC layer and lower layers are installed in the DU, and an interface between the CU and the DU is defined as F1.

### CITATION LIST

### Non-Patent Literature

Non-Patent Document 1: 3GPP TS 38.300 V17.1.0 (2022-06)

### SUMMARY

A communication control method according to a first aspect is a communication control method used in a cellular communication system. The communication control method includes transmitting, at a mobile relay node configured to migrate from a source donor node to a target donor node, an F1 setup request message for requesting establishment of F1 connection to the target donor node in response to reception of a predetermined message from the source donor node. Here, the predetermined message is a message representing one of a new establishment request for F1 connection for the target donor node and a migration indication to the target donor node.

A communication control method according to a second aspect is a communication control method used in a cellular communication system. The communication control method includes broadcasting, at a relay node, a system information block that does not include information representing that another relay node is supported, when the relay node is operating as a mobile relay node.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, Parent nodes, and Child nodes.

FIG. 3 is a diagram illustrating a configuration example of a gNB (base station) according to the embodiment.

FIG. 4 is a diagram illustrating a configuration example of an IAB node (relay node) according to the embodiment.

FIG. 5 is a diagram illustrating a configuration example of a User Equipment (UE) according to the embodiment.

FIG. 6 is a diagram illustrating an example of a protocol stack related to RRC connection and NAS connection of an IAB-MT.

FIG. 7 is a diagram illustrating an example of a protocol stack related to an F1-U protocol.

FIG. 8 is a diagram illustrating an example of the protocol stack related to the F1-C protocol.

FIG. 9 is a diagram illustrating migration examples of a mobile IAB node according to a first embodiment.

FIG. 10 is a diagram illustrating an operation example according to the first embodiment.

FIG. 11 is a diagram illustrating an operation example according to a second embodiment.

FIG. 12 is a diagram illustrating an example of traditional handover (upper part) and an example of a group reconfiguration (lower part).

FIG. 13 is a diagram illustrating a solution 1 for reduction of service interruption.

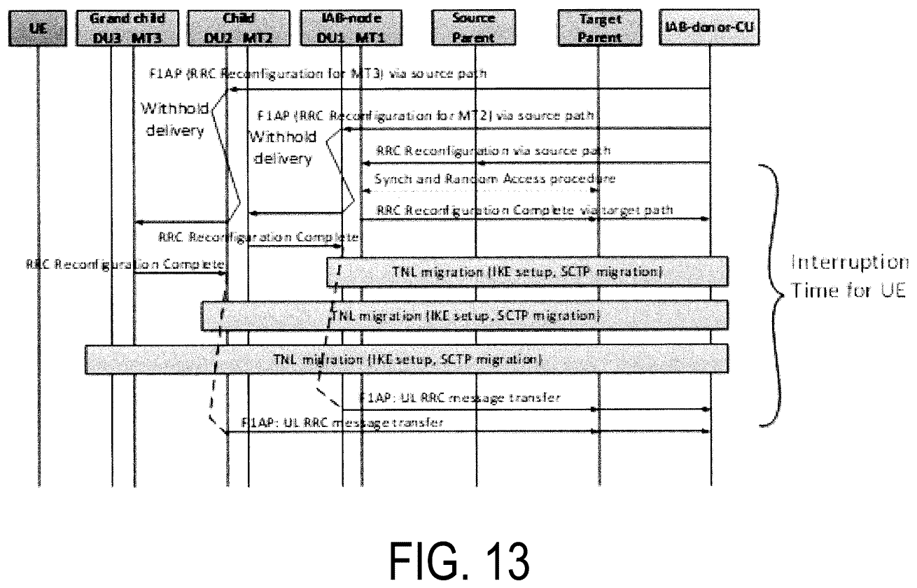

FIG. 14 is a diagram illustrating a solution 2 for reduction of service interruption.

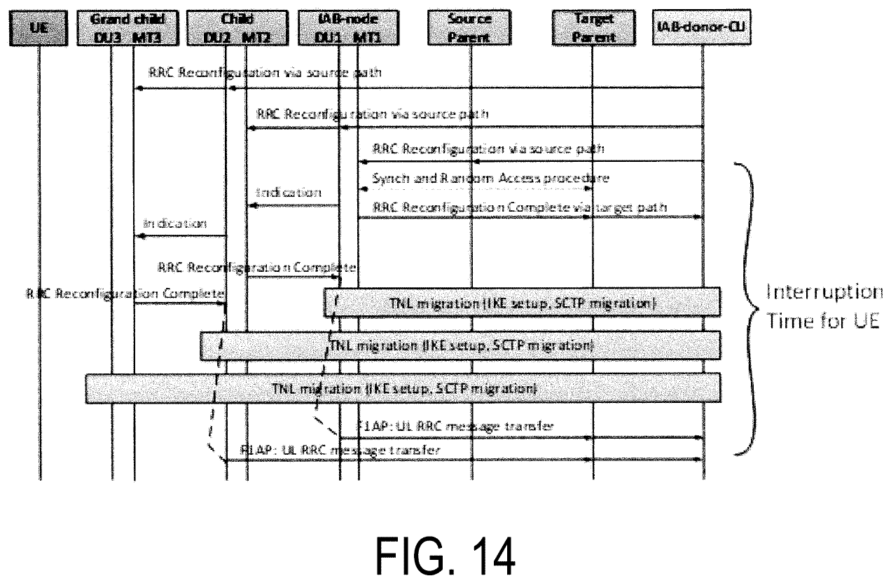

### DESCRIPTION OF EMBODIMENTS

A cellular communication system according to embodiments will be described with reference to the drawings. In the description of the drawings, the same or similar parts are denoted by the same or similar reference signs.

### First Embodiment

### Configuration of Cellular Communication System

A configuration example of the cellular communication system according to an embodiment will be described. A cellular communication system 1 according to the embodiment is a 3GPP 5G system. More specifically, a radio access scheme in the cellular communication system 1 is New Radio (NR) that is a 5G radio access scheme. Note that Long Term Evolution (LTE) may be at least partially applied to the cellular communication system 1. A future cellular communication system such as 6G may be also applied to the cellular communication system 1.

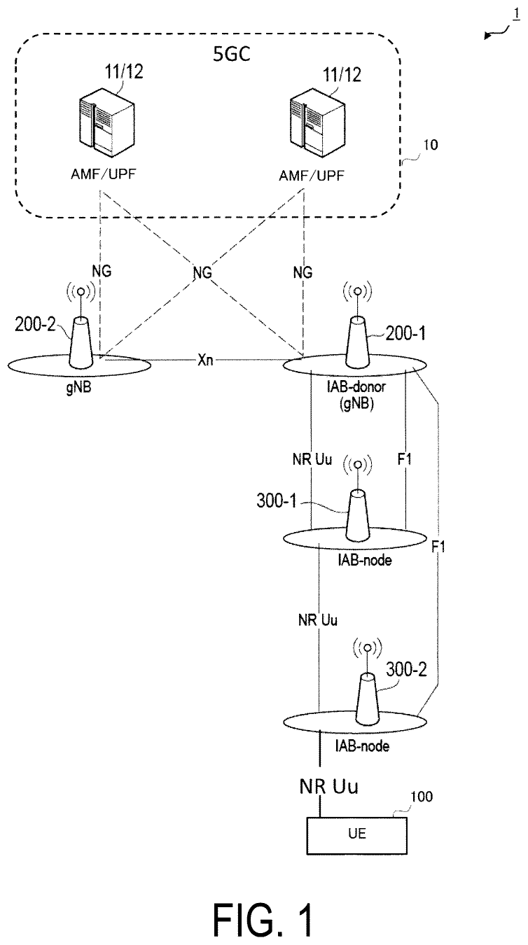

FIG. 1 is a diagram illustrating the configuration example of the cellular communication system 1 according to the embodiment.

As illustrated in FIG. 1, the cellular communication system 1 includes a 5G core network (5GC) 10, a User Equipment (UE) 100, base station devices (hereinafter, also referred to as “base stations” in some cases) 200-1 and 200-2, and IAB nodes 300-1 and 300-2. A base station 200 may be referred to as a gNB.

An example where the base station 200 is an NR base station will be mainly described below. However, the base station 200 may be an LTE base station (i.e., eNB).

Note that, in the following description, the base stations 200-1 and 200-2 may be referred to as the gNBs 200 (or base stations 200), and the IAB nodes 300-1 and 300-2 may be referred to as IAB nodes 300.

The 5GC 10 includes an Access and Mobility Management Function (AMF) 11 and a User Plane Function (UPF) 12. The AMF 11 is a device that performs various types of mobility controls and the like for the UE 100. The AMF 11 manages information of an area in which the UE 100 exists by communicating with the UE 100 by using Non-Access Stratum (NAS) signaling. The UPF 12 is a device that performs transfer control of user data and the like.

Each gNB 200 is a fixed wireless communication node and manages one or more cells. A cell is used as a term that indicates a minimum unit of a wireless communication area. The cell is also used as a term indicating a function or a resource for performing wireless communication with the UE 100. One cell belongs to one carrier frequency. Hereinafter, the cell and the base station may be used without distinction.

Each gNB 200 is interconnected to the 5GC 10 via an interface referred to as an NG interface. FIG. 1 illustrates the two gNB 200-1 and gNB 200-2 that are connected to the 5GC 10.

Each gNB 200 may be divided into a Central Unit (CU) and a Distributed Unit (DU). The CU and the DU are interconnected via an interface referred to as an F1 interface. An F1 protocol is a communication protocol between the CU and the DU, and includes an F1-C protocol that is a control plane protocol and an F1-U protocol that is a user plane protocol.

The cellular communication system 1 supports an IAB that enables wireless relay of the NR access using NR for the backhaul. The donor gNB 200-1 (or a donor node that hereinafter may be also referred to as a “donor node”) is a donor base station that is a terminal node of the NR backhaul on the network side and includes additional function of supporting the IAB. The backhaul can implement multi-hop via a plurality of hops (i.e., a plurality of the IAB nodes 300).

FIG. 1 illustrates an example where the IAB node 300-1 wirelessly connects to the donor node 200-1, the IAB node 300-2 wirelessly connects to the IAB node 300-1, and the F1 protocol is transmitted in two backhaul hops.

The UE 100 is a movable wireless communication device that performs wireless communication with the cells. The UE 100 may be any type of a device as long as the UE 100 is a device that performs wireless communication with the gNB 200 or the IAB node 300. For example, the UE 100 includes a mobile phone terminal and/or a tablet terminal, a notebook PC, a sensor or a device that is provided in a sensor, a vehicle or a device that is provided in a vehicle, and an aircraft or a device provided in an aircraft. The UE 100 wirelessly connects to the IAB node 300 or the gNB 200 via an access link. FIG. 1 illustrates an example where the UE 100 is wirelessly connected to the IAB node 300-2. The UE 100 indirectly communicates with the donor node 200-1 via the IAB node 300-2 and the IAB node 300-1.

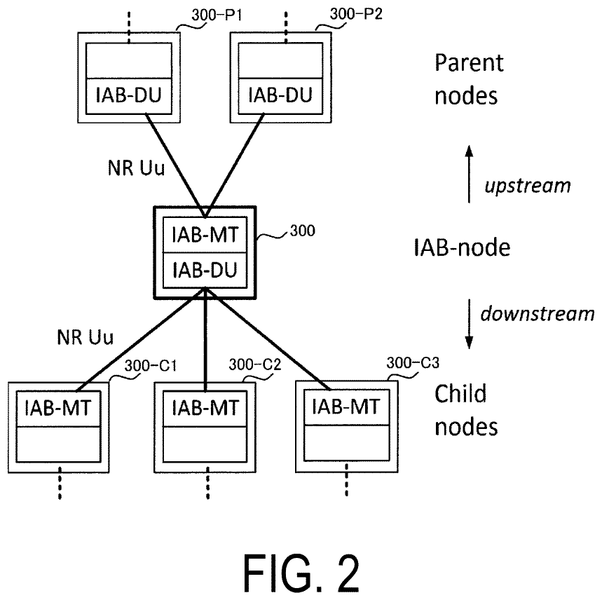

FIG. 2 is a diagram illustrating an example of a relationship between the IAB node 300, Parent nodes, and Child nodes.

As illustrated in FIG. 2, each IAB node 300 includes an IAB-DU corresponding to a base station functional unit, and an IAB-Mobile Termination (IAB-MT) corresponding to a user equipment functional unit.

Neighboring nodes (i.e., upper node) of the IAB-MT in an NR Uu wireless interface are referred to as parent nodes. The parent node is the DU of a parent IAB node or the donor node 200. A radio link between the IAB-MT and each parent node is referred to as a backhaul link (BH link). FIG. 2 illustrates an example where the parent nodes of the IAB node 300 are IAB nodes 300-P1 and 300-P2. Note that the direction toward the parent nodes is referred to as upstream. As viewed from the UE 100, the upper nodes of the UE 100 can correspond to the parent nodes.

Neighboring nodes (i.e., lower nodes) of the IAB-DU in an NR access interface are referred to as child nodes. The IAB-DU manages cells in the same manner as and/or similar manner to that of the gNB 200. The IAB-DU terminates the NR Uu wireless interface to the UE 100 and the lower IAB nodes. The IAB-DU supports the F1 protocol for the CU of the donor node 200-1. FIG. 2 illustrates an example where the child nodes of the IAB node 300 are IAB nodes 300-C1 to 300-C3, but the child nodes of the IAB node 300 may include the UE 100. Note that the direction toward the child nodes is referred to as downstream.

All of the IAB nodes 300 connected to the donor node 200 via one or more hops form a Directed Acyclic Graph (DAG) topology (that may be referred to as a “topology” below) rooted at the donor node 200. In this topology, the neighboring nodes of the IAB-DU in the interface are child nodes, and the neighboring nodes of the IAB-MT in the interface are parent nodes as illustrated in FIG. 2. The donor node 200 performs, for example, centralized management on resources, topology, and roots of the IAB topology. The donor node 200 is a gNB that provides network access to the UE 100 via a network of backhaul links and access links.

### Configuration of Base Station

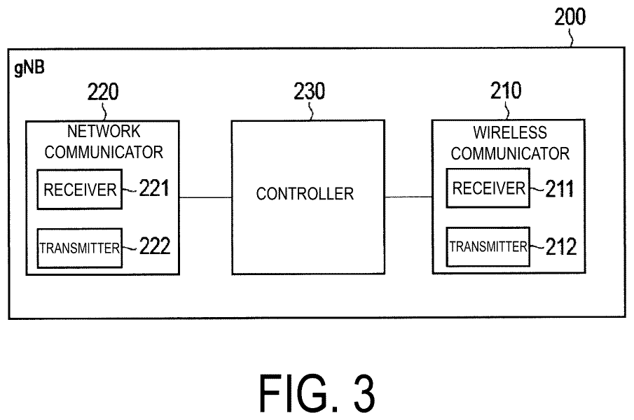

A configuration of the gNB 200 that is the base station according to the embodiment will be described. FIG. 3 is a diagram illustrating a configuration example of the gNB 200. As illustrated in FIG. 3, the gNB 200 includes a wireless communicator 210, a network communicator 220, and a controller 230.

The wireless communicator 210 performs wireless communication with the UE 100 and wireless communication with the IAB node 300. The wireless communicator 210 includes a receiver 211 and a transmitter 212. The receiver 211 performs various types of reception under control of the controller 230. The receiver 211 includes an antenna, and converts (down-converts) a radio signal received by the antenna into a baseband signal (received signal), and outputs the baseband signal to the controller 230. The transmitter 212 performs various types of transmission under control of the controller 230. The transmitter 212 includes an antenna, and converts (up-converts) the baseband signal (transmission signal) output by the controller 230 into a radio signal, and transmits the radio signal from the antenna.

The network communicator 220 performs wired communication (or wireless communication) with the 5GC 10, and wired communication (or wireless communication) with another neighboring gNB 200. The network communicator 220 includes a receiver 221 and a transmitter 222. The receiver 221 performs various types of reception under control of the controller 230. The receiver 221 receives a signal from an external source and outputs the received signal to the controller 230. The transmitter 222 performs various types of transmission under control of the controller 230. The transmitter 222 transmits the transmission signal output by the controller 230 to an external destination.

The controller 230 performs various types of control in the gNB 200. The controller 230 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory and performs various types of processing. The processor performs processing of the layers described below. Note that the controller 230 may perform each processing and each operation in the gNB 200 in each embodiment to be described below.

### Configuration of Relay Node

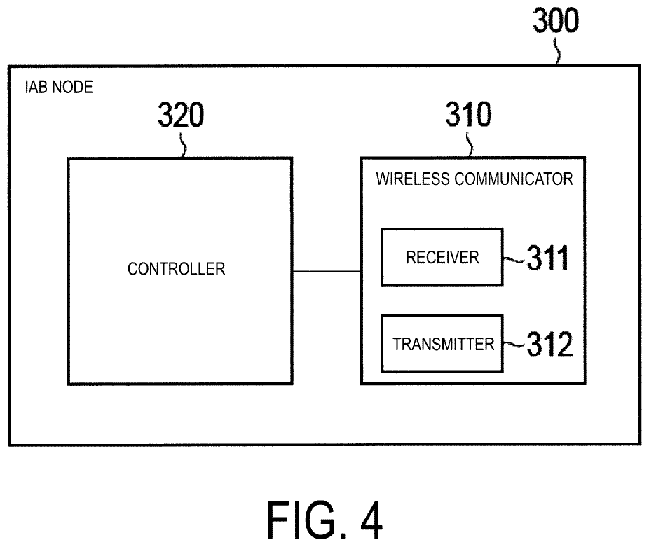

A configuration of the IAB node 300 that is a relay node (or a relay node device that may hereinafter also be referred to as a “relay node” below) according to the embodiment will be described. FIG. 4 is a diagram illustrating a configuration example of the IAB node 300. As illustrated in FIG. 4, the IAB node 300 includes a wireless communicator 310 and a controller 320. The IAB node 300 may include a plurality of wireless communicators 310.

The wireless communicator 310 performs wireless communication with the gNB 200 (BH link) and wireless communication with the UE 100 (access link). The wireless communicator 310 for BH link communication and the wireless communicator 310 for access link communication may be provided separately.

The wireless communicator 310 includes a receiver 311 and a transmitter 312. The receiver 311 performs various types of reception under control of the controller 320. The receiver 311 includes an antenna, and converts (down-converts) a radio signal received by the antenna into a baseband signal (received signal), and outputs the baseband signal to the controller 320. The transmitter 312 performs various types of transmission under control of the controller 320. The transmitter 312 includes an antenna, and converts (up-converts) the baseband signal (transmission signal) output by the controller 320 into a radio signal, and transmits the radio signal from the antenna.

The controller 320 performs various types of control in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory and performs various types of processing. The processor performs processing of the layers described below. Note that the controller 320 may perform each processing and each operation in the IAB node 300 in each embodiment to be described below.

### Configuration of User Equipment

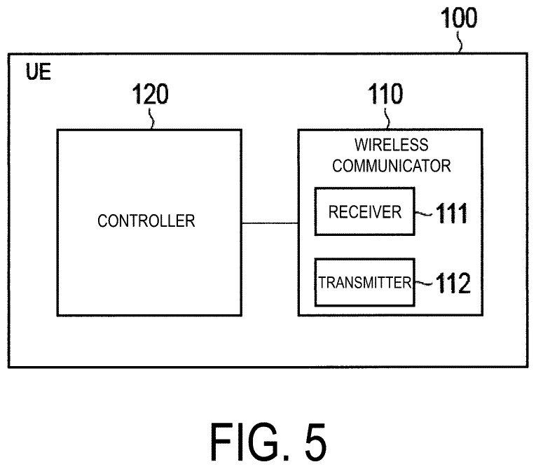

A configuration of the UE 100 that is the user equipment according to the embodiment will be described. FIG. 5 is a diagram illustrating a configuration example of the UE 100. As illustrated in FIG. 5, the UE 100 includes a wireless communicator 110 and a controller 120.

The wireless communicator 110 performs wireless communication in the access link, i.e., wireless communication with the gNB 200 and wireless communication with the IAB node 300. The wireless communicator 110 may also perform wireless communication in a sidelink, i.e., wireless communication with another UE 100. The wireless communicator 110 includes a receiver 111 and a transmitter 112. The receiver 111 performs various types of reception under control of the controller 120. The receiver 111 includes an antenna, and converts (down-converts) a radio signal received by the antenna into a baseband signal (received signal), and outputs the baseband signal to the controller 120. The transmitter 112 performs various types of transmission under control of the controller 120. The transmitter 112 includes an antenna, and converts (up-converts) a baseband signal (transmission signal) output by the controller 120 into a radio signal, and outputs the radio signal from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory and performs various types of processing. The processor performs processing of the layers described below. Note that the controller 120 may perform each processing in the UE 100 in each embodiment described below.

### Configuration of Protocol Stack

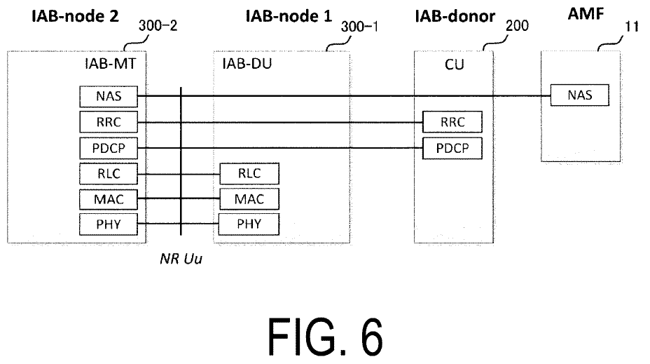

A configuration of a protocol stack according to the embodiment will be described. FIG. 6 is a diagram illustrating an example of a protocol stack related to RRC connection and NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through Hybrid Automatic Repeat reQuest (HARQ: Hybrid ARQ), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines uplink and downlink transport formats (transport block sizes, Modulation and Coding Schemes (MCSs)) and assignment resource blocks.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression and decompression, and encryption and decryption. Data and control information are transmitted between the PDCP layer of the IAB-MT of the IAB node 300-2 and the PDCP layer of the donor node 200 via a radio bearer.

The RRC layer controls a logical channel, a transport channel, and a physical channel according to establishment, re-establishment, and release of a radio bearer. RRC signaling for various configurations is transmitted between the RRC layer of the IAB-MT of the IAB node 300-2 and the RRC layer of the donor node 200. When RRC connection with the donor node 200 is established, the IAB-MT is in an RRC connected state. When no RRC connection to the donor node 200 is established, the IAB-MT is in an RRC idle state.

The NAS layer that is positioned upper than the RRC layer performs session management, mobility management, and the like. NAS signaling is transmitted between the NAS layer of the IAB-MT of the IAB node 300-2 and the AMF 11.

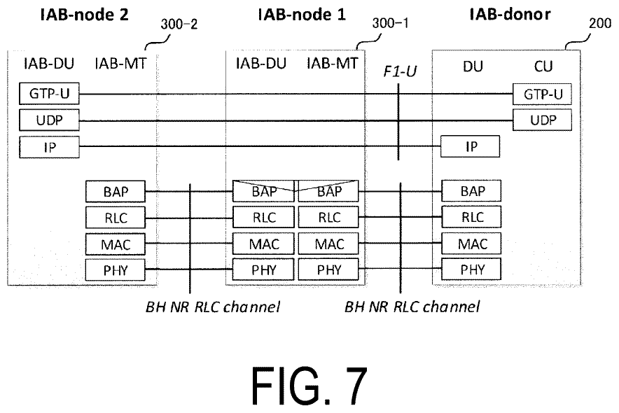

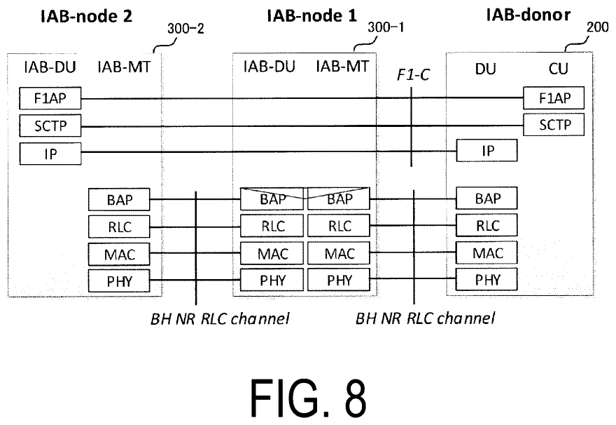

FIG. 7 is a diagram illustrating a protocol stack related to an F1-U protocol. FIG. 8 is a diagram illustrating a protocol stack related to an F1-C protocol. An example will be described where the donor node 200 is divided into a CU and a DU.

As illustrated in FIG. 7, each of the IAB-MT of the IAB node 300-2, the IAB-DU of the IAB node 300-1, the IAB-MT of the IAB node 300-1, and the DU of the donor node 200 includes a Backhaul Adaptation Protocol (BAP) layer as an upper layer of the RLC layer. The BAP layer performs routing processing, and bearer mapping and demapping processing. In the backhaul, the IP layer is transmitted via the BAP layer to enable routing through a plurality of hops.

In each backhaul link, a Protocol Data Unit (PDU) of the BAP layer is transmitted on the backhaul RLC channel (BH NR RLC channel). Configuring a plurality of backhaul RLC channels in each BH link enables the prioritization and Quality of Service (QOS) control of traffic. The association between the BAP PDU and the backhaul RLC channel is executed by the BAP layer of each IAB node 300 and the BAP layer of the donor node 200.

As illustrated in FIG. 8, the protocol stack of the F1-C protocol includes an F1AP layer and an SCTP layer instead of a GTP-U layer and a UDP layer illustrated in FIG. 7.

Note that, in the description below, processing or an operation performed by the IAB-DU and the IAB-MT of the IAB may be simply described as processing or an operation of the “IAB”. The description assumes that, for example, transmitting a message of the BAP layer from the IAB-DU of the IAB node 300-1 to the IAB-MT of the IAB node 300-2 is to transmit the message from the IAB node 300-1 to the IAB node 300-2. Processing or an operation of the DU or CU of the donor node 200 may be described simply as processing or an operation of the “donor node”.

An upstream direction and an uplink (UL) direction may be used without distinction. A downstream direction and a downlink (DL) direction may be used without distinction.

### Mobile IAB Node

Currently, 3GPP has started a study for introducing a mobile IAB node. The mobile IAB node is, for example, an IAB node that is moving. The IAB node may be a movable IAB node. The mobile IAB node may be an IAB node having the capability to move. The mobile IAB node may be an IAB node that is currently stationary, but is certain to move in the future (or is expected to move in the future).

The mobile IAB node enables, for example, the UE 100 subordinate to the mobile IAB node to receive provision of services from the mobile IAB node as the mobile IAB node moves. For example, a case is assumed where a user (or the UE 100) who is in a vehicle receives provision of a service via the mobile IAB node installed in the vehicle.

On the other hand, there is also an IAB node that does not move with respect to the mobile IAB node. Such an IAB node may be referred to as an intermediate IAB node. The intermediate IAB node is, for example, an IAB node that does not move. The intermediate IAB node may be a stationary IAB node. The intermediate IAB node may be a stationary IAB node. The intermediate IAB node may be an IAB node that is installed at an installation place and is stationary (or does not migrate). The intermediate IAB node may be a stationary IAB node that does not migrate. The intermediate IAB node may be a fixed IAB node.

The mobile IAB node can also connect to the intermediate IAB node. The mobile IAB node can also connect to the donor node 200. The mobile IAB node can also change a connection destination by migration (or handover). A connection source may be the intermediate IAB node. The connection source may be the donor node 200. The connection destination may be the intermediate IAB node. The connection destination may be the donor node 200.

Note that, in the following description, migration of the mobile IAB node and handover of the mobile IAB node may be used without distinction.

In the following description, the mobile IAB node may be a “mobile IAB node”. The mobile IAB node may be a “migrating IAB node”. In either case, the mobile IAB node may be referred to as a mobile IAB node.

### Partial Migration and Full Migration

A migrating IAB node may migrate between the donor nodes (IAB-donor) 200.

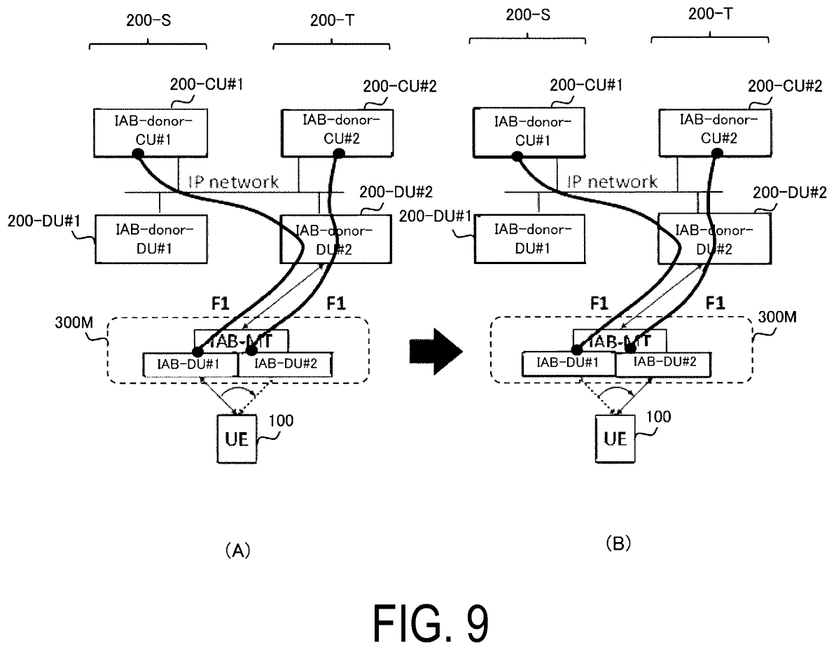

(A) of FIG. 9 and (B) of FIG. 9 are diagrams illustrating migration examples of a mobile IAB node 300M according to a first embodiment. (A) of FIG. 9 and (B) of FIG. 9 illustrate an example where the mobile IAB node 300M migrates from a source donor node 200-S to a target donor node 200-T.

(A) of FIG. 9 illustrates an example of partial migration, and (B) of FIG. 9 illustrates an example of full migration.

As illustrated in (A) of FIG. 9, in the partial migration, while an IAB-DU #1 of the mobile IAB node 300M (and the UE 100) is terminated at a CU #1 (200-CU #1) of the source donor node 200-S, the IAB-MT of the mobile IAB node 300M migrates to a CU #2 (200-CU #2) of the target donor node 200-T. Partial migration refers to, for example, a state where connection of the UE 100 subordinate to the mobile IAB node 300M remains in the source donor node 200-S via the IAB-DU #1 of the mobile IAB node 300M.

On the other hand, as illustrated in (B) of FIG. 9, in the full migration, connection of the mobile IAB node 300M (and the UE 100) migrates from the CU #1 (200-CU #1) of the source donor node 200-S to the CU #2 (200-CU #2) of the target donor node 200-T. Full migration refers to, for example, a state where connection of the UE 100 migrates to the target donor node 200-T via an IAB-DU #2 of the mobile IAB node 300M.

Here, it is necessary that the IAB-DU #2 is logically established in the mobile IAB node 300M, and that F1 connection is established between the IAB-DU #2 and the CU #2 (200-CU #2) of the target donor node 200-T to implement full migration. This is because the UE 100 can exchange various messages with the target donor node 200-T via the IAB-DU #2.

To establish the F1 connection between the IAB-DU #2 and the CU #2 (200-CU #2) of the target donor node 200-T, it is necessary to transmit an F1 SETUP REQUEST from the mobile IAB node 300M to the CU #2 (200-CU #2) of the target donor node 200-T.

However, the mobile IAB node 300M does not know at what timing to transmit the F1 SETUP REQUEST. When the F1 SETUP REQUEST is not transmitted at an appropriate timing, the F1 connection with the target donor node 200-T cannot be established, and full migration may not be executed. Therefore, the UE 100 subordinate to the mobile IAB node 300M may not be able to appropriately connect to the network.

Hence, the UE 100 is enabled to appropriately connect to the network in the first embodiment.

In the first embodiment, a source donor node (e.g., source donor node 200-S) transmits a new establishment request for F1 connection for a target donor node to a mobile relay node (e.g., mobile IAB node) that migrates from the source donor node to the target donor node (e.g., target donor node 200-T).

Thus, for example, the mobile IAB node 300M may transmit the F1 SETUP REQUEST message in response to reception of the new establishment request from the source donor node 200-S, and consequently can transmit the message at an appropriate timing. Accordingly, the mobile IAB node 300M can establish F1 connection via the IAB-DU #2 at an appropriate timing, and execute full migration. Accordingly, the UE 100 can connect to the network via the IAB-DU #2, and consequently can connect to the network at an appropriate timing.

### Operation Example According to First Embodiment

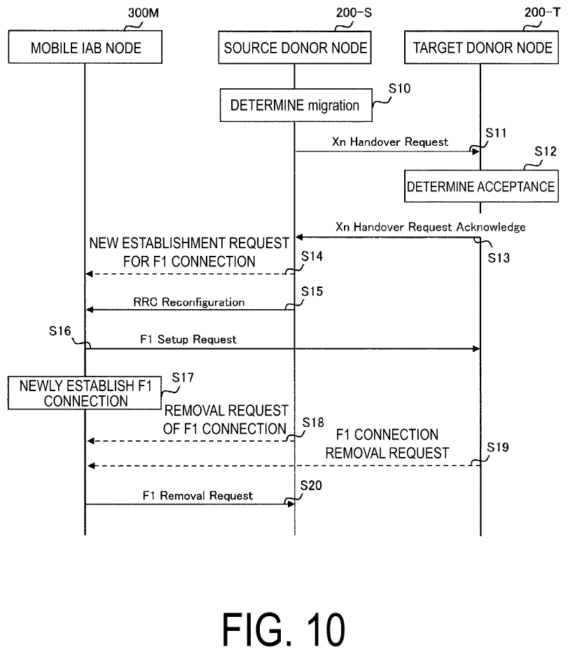

FIG. 10 is a diagram illustrating an operation example according to the first embodiment.

FIG. 10 illustrates an example where the mobile IAB node 300M migrates from the source donor node 200-S to the target donor node 200-T to execute full migration. The source donor node 200-S may include the CU #1 (200-CU #1) and a DU #1 (200-DU #1) of the source donor node 200-S illustrated in (B) of FIG. 9. The target donor node 200-T may also include the CU #2 (200-CU #2) and a DU #2 (200-DU #2) of the target donor node 200-T illustrated in (B) of FIG. 9.

As illustrated in FIG. 10, in step S10, the source donor node 200-S determines migration of the mobile IAB node 300M. The CU of the source donor node 200-S may determine the migration in response to reception of a measurement report from the IAB-MT of the mobile IAB node 300M via the DU of the source donor node 200-S.

In step S11, the source donor node 200-S transmits to the target donor node 200-T a HANDOVER REQUEST message for the mobile IAB node 300M. The source donor node 200-S may include in the message an execution request for requesting execution of full migration by the mobile IAB node 300M to transmit. The source donor node 200-S may include, in the message, information indicating whether the mobile IAB node 300M executes full migration. The source donor node 200-S may include in the message an execution request for requesting execution of partial migration by the mobile IAB node 300M. The source donor node 200-S may include, in the message, information indicating whether the mobile IAB node 300M executes partial migration. For example, the CU of the source donor node 200-S transmits the HANDOVER REQUEST message that is an Xn message to the CU of the target donor node 200-T.

In step S12, the target donor node 200-T determines to accept handover according to the HANDOVER REQUEST message. The target donor node 200-T determines to perform full migration. For example, the CU of the target donor node 200-T determines acceptance of handover and execution of full migration in response to reception of the HANDOVER REQUEST message.

In step S13, the target donor node 200-T transmits a HANDOVER REQUEST ACKNOWLEDGE message to the source donor node 200-S. For example, the CU of the target donor node 200-T transmits the message that is an Xn message to the CU of the source donor node 200-S in response to determination of acceptance of handover (step S12).

The HANDOVER REQUEST ACKNOWLEDGE message includes an RRCReconfiguration message for the mobile IAB node 300M. The RRCReconfiguration message may include information for requesting new establishment of F1 connection. The RRCReconfiguration message may include information that indicates execution of full migration. Note that the RRCReconfiguration message functions as, for example, a handover command for indicating handover to the mobile IAB node 300M.

In step S14, the source donor node 200-S may transmit a new establishment request for F1 connection to the mobile IAB node 300M. For example, in response to reception of the HANDOVER REQUEST ACKNOWLEDGE message (step S13), the CU of the source donor node 200-S generates an F1 message including the new establishment request for F1 connection, and transmits the generated F1 message to the IAB-DU of the mobile IAB node 300M. The CU of the source donor node 200-S may transmit the F1 message prior to determination of migration of the mobile IAB node 300M (step S10). The CU of the source donor node 200-S may transmit the F1 message immediately after determination of migration. Note that the new establishment request may be included in the RRCReconfiguration message in step S13 described above and step S15 described below and transmitted. In this case, step S14 may be omitted.

In step S15, the source donor node 200-S transmits the RRCReconfiguration message included in the HANDOVER REQUEST ACKNOWLEDGE message (step S13) to the mobile IAB node 300M. For example, the following processing is performed. That is, the CU of the source donor node 200-S extracts the RRCReconfiguration message from the HANDOVER REQUEST ACKNOWLEDGE message received in step S13, and transmits the F1 message including the RRCReconfiguration message to the DU of the source donor node 200-S. The DU of the source donor node 200-S extracts the RRCReconfiguration message from the F1 message, and transmits the RRCReconfiguration message to the IAB-MT of the mobile IAB node 300M. The RRCReconfiguration message may be a new establishment request for F1 connection for the target donor node 200-T. The RRCReconfiguration message may include information representing the new establishment request for the F1 connection for the target donor node 200-T. When an AS layer receives the new establishment request for the F1 connection, the request may be notified to an upper layer (F1 AP layer).

In step S16, when receiving one of the F1 message (step S14) and the RRCReconfiguration message (step S15) including the new establishment request for the F1 connection, the mobile IAB node 300M recognizes that new establishment of the F1 connection to the target donor node 200-T is necessary.

The mobile IAB node 300M transmits to the target donor node 200-T an F1 SETUP REQUEST message for requesting establishment of the F1 connection. That is, the mobile IAB node 300M transmits the F1 SETUP REQUEST message in response to reception of the new establishment request for the F1 connection (step S14 or step S15). For example, the IAB-DU of the mobile IAB node 300M transmits the F1 SETUP REQUEST message to the CU of the target donor node 200-T. The mobile IAB node 300M may transmit the F1 SETUP REQUEST message via the source donor node 200-S.

In step S17, the mobile IAB node 300M newly establishes F1 connection with the target donor node 200-T. Thus, the “IAB-DU #2” illustrated in (B) of FIG. 9 is present in the mobile IAB node 300M. The mobile IAB node 300M establishes F1 connection with the CU of the target donor node 200-T via the “IAB-DU #2”, and consequently can execute full migration.

The mobile IAB node 300M performs processing for removing the F1 connection to the source donor node 200-S when full migration is completed. The F1 connection is, for example, F1 connection from the “IAB-DU #1” to the CU #1 (200-CU #1) of the source donor node 200-S illustrated in (B) of FIG. 9. Full migration may be completed when handover of all of the UEs 100 subordinate to the mobile IAB node 300M is completed.

In step S18, when the source donor node 200-S transmits a removal request of the F1 connection to the mobile IAB node 300M, the F1 connection may be removed. For example, the CU of the source donor node 200-S may transmit the F1 message including the removal request of the F1 connection to the IAB-DU of the mobile IAB node 300M.

In step S19, the target donor node 200-T may transmit the removal request of the F1 connection. In this case, too, an F1 message including the removal request of the F1 connection may be transmitted. For example, the CU of the target donor node 200-T may transmit the F1 message including the removal request of the F1 connection to the IAB-DU of the mobile IAB node 300M. The CU of the target donor node 200-T may transmit an F1 message including information indicating completion of full migration instead of the removal request of the F1 connection.

In step S20, when there is no more UE context (or all UE contexts are released) in the F1 connection (F1 entity) connected with the source donor node 200-S, the mobile IAB node 300M determines that full migration has been completed. The mobile IAB node 300M transmits an F1 REMOVAL REQUEST message for removal of the F1 connection to the source donor node 200-S.

The mobile IAB node 300M may transmit the F1 REMOVAL REQUEST message in response to reception of one of the removal request of the F1 connection from the source donor node 200-S (step S18) and the removal request of the F1 connection from the target donor node 200-T (step S19).

As described above, the mobile IAB node 300M transmits the F1 REMOVAL REQUEST message in response to reception of the removal request of the F1 connection for the source donor node 200-S from the source donor node 200-S or the target donor node 200-T. Accordingly, the mobile IAB node 300M can transmit the F1 REMOVAL REQUEST message to the source donor node 200-S at an appropriate timing.

### Second Embodiment

A second embodiment will be described.

3GPP has proposed that the mobile IAB node 300M does not need to be connected as a child node or a grandchild node to the IAB node 300, yet is connected only to the UE 100. This is because it is assumed that, when the IAB node 300 is connected as a child node or a grandchild node to the mobile IAB node 300M, not only control of the IAB node, but also control of the UE subordinate to the IAB node become complicated.

There is a problem of how to connect only the UE 100 to the mobile IAB node 300M.

In the second embodiment, by enabling only the UE 100 to connect to the mobile IAB node 300M, the UE 100 is enabled to appropriately connect to the network.

Hence, in the second embodiment, when the IAB node 300 is operating as the mobile IAB node 300M, the IAB node 300 does not configure, to an SIB1, IAB support information (iab-Support IE) that is an information element representing that the IAB node is supported. That is, the IAB node 300 broadcasts the SIB1 that does not include the IAB support information.

More specifically, when a relay node (e.g., IAB node 300) is operating as a mobile relay node (e.g., mobile IAB node 300M), the relay node broadcasts a system information block (e.g., SIB1) that does not include information (e.g., IAB support information) representing that another relay node is supported.

Thus, the IAB-MT of the IAB node 300 that has received the SIB1 recognizes that the IAB node that has broadcast the SIB1 (or the cell that has broadcast the SIB1) does not support the IAB node. Hence, the IAB-MT of the IAB node 300 that has received the SIB1 does not perform connection processing (e.g., a cell selection procedure or a cell reselection procedure) on the IAB node that has broadcast the SIB1.

Even when the IAB support information is not included in the SIB, since the IAB support information is the information element for the IAB node 300, the UE 100 that has received the SIB1 is not restricted from connecting to the own IAB node 300.

Accordingly, the IAB node 300 that operates as the mobile IAB node 300M does not have another IAB node as a child node or a grandchild node, but has only the UE 100.

Accordingly, the UE 100 subordinate to the mobile IAB node 300M can appropriately connect to the network.

### Operation Example According to Second Embodiment

An operation example according to a second embodiment will be described.

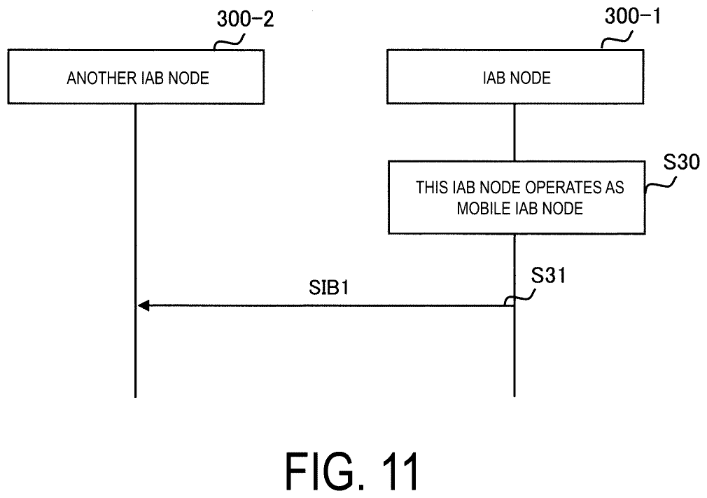

FIG. 11 is a diagram illustrating the operation example according to the second embodiment.

As illustrated in FIG. 11, in step S30, the IAB node 300-1 determines that the IAB node 300-1 is operating as the mobile IAB node 300M. The IAB node 300-1 determines in, for example, the following manner that the IAB node 300-1 is operating as the mobile IAB node 300M.

First, based on a fact that the IAB node 300-1 is migrating, the IAB node 300-1 may determine that the IAB node 300-1 is operating as the mobile IAB node 300M. The IAB node 300-1 may determine that IAB node 300-1 is migrating based on a detection result of an acceleration sensor or a Global Navigation Satellite System (GNSS) received signal received by a GNSS receiver.

Second, when the core network (CN) authorizes the IAB node 300-1 to operate as the mobile IAB node 300M, the IAB node 300-1 may determine that the IAB node 300-1 is operating as the mobile IAB node 300M. By receiving a message including information representing the authorization from the AMF 11 or the like, the IAB node 300-1 may determine that the IAB node 300-1 has been authorized.

Third, when the donor node 200 authorizes the IAB node 300-1 to be operating as the mobile IAB node 300M, the IAB node 300-1 may determine that the IAB node 300-1 is operating as the mobile IAB node 300M. By receiving the message including the information representing the authorization from the donor node 200, the IAB node 300-1 may determine that the IAB node 300-1 has been authorized. When a specific configuration of the mobile IAB node 300M is configured by the donor node 200, the IAB node 300-1 may implicitly determine that the IAB node 300-1 has been authorized as the mobile IAB node 300M.

Note that, when the IAB node 300 is authorized to operate as the mobile IAB node 300M in the upper layer, the authorization may be output to the AS layer.

In step S31, the IAB node 300-1 does not transmit the IAB support information when the IAB node 300-1 is operating as the mobile IAB node 300M. That is, the IAB node 300-1 broadcasts an SIB1 that does not include the IAB support information. The IAB node 300-1 may broadcast a system information block (e.g., SIB1) that includes information indicating that the IAB node 300-1 is the mobile IAB node 300M. The IAB node 300-1 may broadcast a system information block (e.g., SIB1) that includes information indicating that the IAB node 300-1 is not an intermediate IAB node 300S.

Another IAB node 300-2 that has received the SIB1 excludes a cell of the IAB node 300-1 that has broadcast the SIB1 (step S31) from candidate cells for the cell selection procedure or the cell reselection procedure. Thus, another IAB node 300-2 is not connected to the IAB node 300-1 that has broadcast the SIB1.

The phrases “based on” and “depending on” used in the present disclosure do not mean “based only on” and “only depending on”, unless specifically stated otherwise. The phrase “based on” means both “based only on” and “based at least in part on”. The phrase “depending on” means both “only depending on” and “at least partially depending on” likewise. The terms “include” and “comprise” do not mean the inclusion of only the listed items but rather the inclusion of only the listed items or the inclusion of additional items in addition to the listed items. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure.

### First Supplementary Note

### Supplementary Note 1

A communication control method used in a cellular communication system includes the step of, at a source donor node, transmitting to a mobile relay node configured to migrate from the source donor node to a target donor node a new establishment request for F1 connection for the target donor node.

### Supplementary Note 2

The communication control method described in Supplementary Note 1 further includes the step of, at the mobile relay node, transmitting to the target donor node an F1 SETUP REQUEST message for requesting establishment of the F1 connection in response to reception the new establishment request.

### Supplementary Note 3

The communication control method described in Supplementary Note 1 or Supplementary Note 2 further includes the step of, at the source donor node, transmitting to the target donor node an execution request for requesting execution of full migration by the mobile relay node, and the full migration is a state where connection of the mobile relay node is migrated from a CU of the source donor node to a CU of the target donor node.

### Supplementary Note 4

The communication control method described in any one of Supplementary Note 1 to Supplementary Note 3 further includes the step of, at the source donor node or the target donor node, transmitting to the mobile relay node a removal request of the F1 connection for the source donor node.

### Supplementary Note 5

The communication control method described in any one of Supplementary Note 1 to Supplementary Note 4 further includes the step of, at the mobile relay node, transmitting to the source donor node an F1 REMOVAL REQUEST message for requesting removal of the F1 connection for the source donor node in response to reception of the removal request.

### Supplementary Note 6

A communication control method used in a cellular communication system includes the step of, at a relay node, broadcasting a system information block that does not include information representing that another relay node is supported when the relay node is operating as a mobile relay node.

### Supplementary Note 7

According to the communication control method described in Supplementary Note 6, the step of broadcasting includes the step of, at the relay node, broadcasting the system information block including information indicating that the relay node is the mobile relay node.

### Second Supplementary Note

### 1. Introduction

RAN #94e has approved a new work item related to a mobile IAB. This WID has been revised in RAN #96 as follows.

A detailed target of this work item is follows.
A transition/topology adaptation procedure to enable mobility of IAB nodes is defined. This includes inter-donor transition (complete transition) of all the mobile IAB nodes.
Mobility of the IAB node and a UE for which this IAB node serves is enhanced. This includes an aspect related to group mobility. Optimization is not performed targeting at surrounding UEs.

Note: The solution needs to be suppressed from touching on a topic that has already been discussed for Rel-17 or a topic that has been excluded from Rel-17 except for enhancement of functions specific to IAB node mobility.
Mitigation of an interference due to mobility of the IAB node such as collision of a reference signal and a control signal (such as a PCI and a RACH) needs to be avoided.

Note: At a time of start of work, RAN3 and RAN2 need to discuss potential complexity between a scenario that the mobile IAB node connects to a stationary (intermediate) IAB node and a scenario that the mobile IAB node directly connects to an IAB donor.

The following principles need to be respected.
The mobile IAB node needs to be able to provide a service to legacy UEs.
Solutions that provide optimization for a mobile IAB may require extended functions of Ues according to Rel-18, but are limited only to a case where such an extended function has backward compatibility.

One of the main tasks of Rel-18 is a method of efficiently executing handover on a plurality of descendant Ues during transition of the mobile IAB node. This supplementary note provides an initial discussion on mobility enhancement for a mobile IAB from a viewpoint of handover of the UE.

### 2. Discussion

### 2.1 Group Reconfiguration

Group UE mobility is expected to be one of the possible enhancement measures for the mobile IAB. This is because, when the mobile IAB node moves to a new IAB donor, many Ues need to be handed over simultaneously.

According to the current specification, handover is indicated by dedicated signaling, i.e. RRC reconfiguration and synchronization. This means that a plurality of individual messages are simultaneously transmitted to respective Ues. Accordingly, a group reconfiguration may be considered as a candidate for reducing a signaling overhead and delay. Thus, it is expected to reconfigure a plurality of Ues by one message.

The group reconfiguration has already been discussed as a “common RRC structure” of the MBS according to Rel-17, and the following summary has been provided.

### Summary on Common RRC Structure

### CONCLUSION

Opinions that standardization of the common RRC configuration cannot be achieved are 16 to 5 and occupy the majority. From the reporter's point of view, there seems to be no technical restriction to suppress the standardization, but there seems to be a big opposition to standardize the RRC configuration. It is generally understood that adoption of the common RRC structure increases an overhead of a Uu signal, yet an F1/E1 signal has an advantage. However, considering standpoints of companies, it has been proposed to maintain the current RRC signal structure.

Proposal 2: A current CRRRC structure is maintained, and the common RRC structure is not advanced (i.e. there is no influence on RRCCR).

The point is that the UE needs to receive an individual RRC reconfiguration and, in addition, needs to receive a group RRC reconfiguration. Hence, there has been a common view that the MBS has little advantage (a disadvantage instead) for the Uu signal, but the F1/E1 signal may have some advantages. As a result, RAN2 has determined to maintain the current structure. That is, only the individual RRC reconfiguration is performed.

In a case of P2, RAN2 assumes that RRC continues to use a dedicated UE configuration if an agreement is reached.

The same/similar concerns apply to the mobile IAB. That is, different Ues have different configurations, and the different configurations of the different Ues cannot be processed by one group reconfiguration. The mobile IAB is also more useful than the MBS to reduce an F1 signal. However, the backhaul link is generally assumed on FR2, and therefore it is still important to reduce signals in an access link.

WID explicitly describes “the discussion on Rel-17 has already been made, and the solution needs to be avoided except for improvement specialized in mobility of IAB nodes so as not to touch points whose topics have been excluded from Rel-17”, and therefore RAN2 does not need to reopen the group reconfiguration (or common RRC structure) in the mobile IAB according to Rel-18, which is true at least from the viewpoint of RAN2.

Proposal 1: RAN2 needs to agree to use only an individual RRC reconfiguration as it is for handover of the UE performed as the mobile IAB node moves.

### 2.2 Handover for Legacy Ues

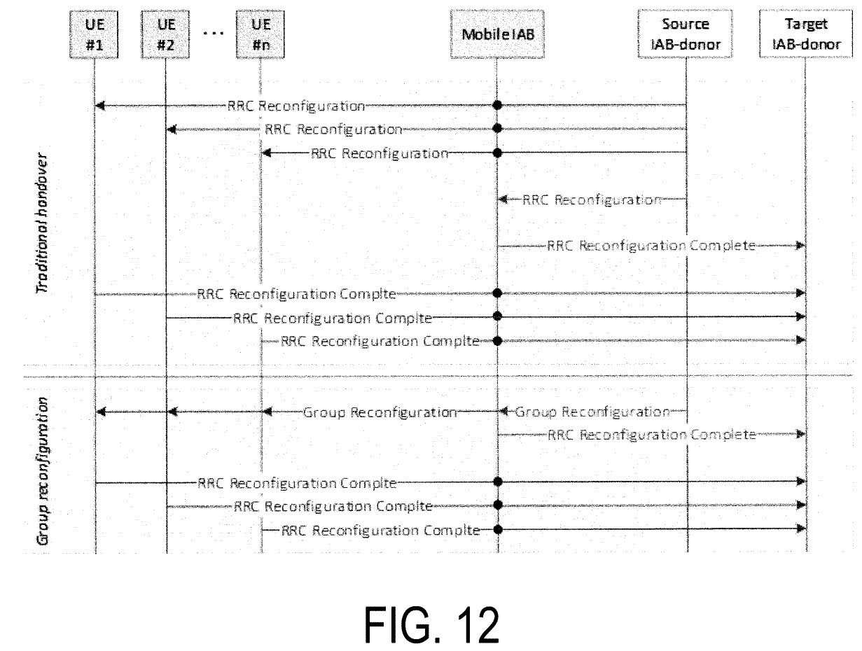

As indicated in Work Item Description (WID), “the mobile IAB node needs to support the legacy Ues”, and therefore RAN2 needs to study a handover method for the legacy Ues. RAN3 has had two solutions for reduction of service interruption during transition of inter-donor IAB nodes according to Rel-17. The solution 1 of these solutions is illustrated in following FIG. 12.

According to the solution 1, the IAB-DU suspends the RRCReconfiguration message to a child node at a time of completion of handover. RAN2 has concluded that both of the solutions need further discussion, yet determined that the solution 1 causes a less overall influence than the solution 2.

Naturally, handover of the UE can be also executed without the solution 1. In this regard, similar to a problem of the IAB node according to Rel-17, handover of a descendant UE is involved. Therefore, when the solution 1 is not applied, the UE experiences service interruption during transition of the moving IAB node. Accordingly, RAN2 needs to assume that the solution 1 for intra-donor transition is reused to reduce service interruption of the legacy Ues during transition of the inter-donor mobile IAB node.

Proposal 2: RAN2 needs to assume that the solution 1 for reducing the service interruption during transition of the intra-donor IAB node according to Rel-17 can be reused for handover of the legacy Ues.

### 2.3 Conditional Reconfiguration

When the individual RRC reconfigurations are simultaneously transmitted to Ues, a load of radio resources may increase due to many RRC messages and responses associated with the RRC messages. The conditional reconfiguration is considered useful for load balancing, that is, balancing in the time domain. This is to enable the IAB donor to avoid simultaneous transmission of many messages from the IAB node by reconfiguring the moving IAB node in advance. The solution 2 for reduction of service interruption according to Rel-17 has a similar solution.

Observation 1: The conditional reconfiguration may help the IAB donor balance RRCReconfiguration messages in the time domain.

Depending on how the mobile IAB-DU processes a cell, and in part due to determination of RAN3, it may be necessary for the mobile IAB-DU to change a cell ID after transition of the mobile IAB node. This is, for example, a case where changes are necessary to avoid PCI collision at a target topology. In this case, although the UE also needs to move from an old cell (a cell that disappears) to a new cell (a cell that becomes available), both of the cells are managed by the same mobile IAB-DU. For such “cell shift”, the conditional reconfiguration is considered more effective than conventional HO commands.

Observation 2: When a serving cell ID is changed due to transition of the mobile IAB node, the conditional reconfiguration may efficiently function.

Taking the above examples (but the examples are not limited thereto) into account, improvement of the conditional reconfiguration may be worth discussion for RAN2. Examples of the discussion include studying whether an existing trigger condition can be reused for the mobile IAB.

Proposal 3: RAN2 needs to study whether the conditional reconfiguration to the UE can be enhanced for improvement of mobility of the mobile IAB node.

### 2.4 RACH-Less Handover

According to the current specification, the UE needs to first start a random access procedure when receiving an HO command. In this regard, when the target cell is the same as the source cell, that is, when the same IAB-DU processes both of the cells, only cell IDs may be different. In this case, since timing advance is also the same between both of the cells, PRACH transmission is unnecessary. RAN2 needs to study whether to specify RACH-less handover for improvement of mobility of the mobile IAB. Since RACH-less handover is applied only to Ues according to Rel-18, attention is necessary.

Proposal 4: RAN2 needs to study whether RACH-less handover of the Ues according to Rel-18 performed as the mobile IAB node moves is useful.

### 2.5 Lossless Handover

A problem of packet loss due to hop-by-hop ARQ has been discussed at a study phase. This problem is observed “when an IAB topology is changed after a failure of a hop-by-hop haul link or when inter-CU handover occurs”. According to Rel-16/17, this problem is a rare case in the assumption of deployment using stationary (still) IAB nodes, and therefore has not been pursued.

According to the mobile IAB according to Rel-18, when the mobile IAB node is an access IAB node at all times, such packet loss is still considered as a rare case. The justified part of WID describes the assumption that “the mobile IAB node does not have a descendant IAB node, that is, the mobile IAB node provides a service to only a UE”. Accordingly, this assumption needs to be confirmed by RAN2.

Proposal 5: RAN2 needs to confirm that the mobile IAB node is the access IAB node at all times, and packet loss due to hop-by-hop ARQ is a rare case in the mobile IAB according to Rel-18.

As for general packet loss, even legacy handover enables a PDCP sublayer of the UE to perform processing of recovering data in the same manner as and/or a similar manner to the current manner. Hence, improvement for lossless handover of the UE performed as the mobile IAB node moves is not scheduled.

Proposal 6: RAN2 needs to agree that the data recovery of the PDCP of the existing UE can be used for lossless handover performed as the mobile IAB node moves, that is. Improvement is not necessary.

### 2.6 Other Aspects

WID describes that the mobile IAB node supports only Ues.
The mobile IAB node does not have child nodes, that is, the mobile IAB node needs to support only Ues.

To ensure this restriction, existing IAB support les can be reused. That is, the mobile IAB node does not configure this IE by an SIB1 to suppress access of other IAB nodes and permit the access of the Ues. The problem is how such a restriction is described in the specification. An explicit description in the specification of Stage-2 may help to avoid confusion at a time of implementation of the mobile IAB.

Proposal 7: RAN2 needs to agree to describe in the specification of Stage-2 that the IAB node does not configure an IAB support IE in an SIB when functioning as a mobile IAB node in this release.

1. A communication control method used in a cellular communication system, the communication control method comprising:
transmitting, at a source donor node, to a first DU (Distributed Unit) of a mobile relay node configured to migrate from the source donor node to a target donor node, a new establishment request for F1 connection for the target donor node, wherein
the F1 connection is established between a second DU of the mobile relay node and the target donor node.

2. The communication control method according to claim 1, further comprising:
transmitting, at the second DU of the mobile relay node, to the target donor node, an F1 setup request message for requesting establishment of the F1 connection in response to reception of the new establishment request.

3. The communication control method according to claim 1, further comprising:
transmitting, at the source donor node, to the first DU of the mobile relay node, a removal request of the F1 connection for the source donor node.

4. A donor node in a cellular communication system, the donor node comprising a transceiver circuitry and a processing circuitry operatively associated with the transceiver circuitry and configured to execute processing of:
transmitting, to a first DU (Distributed Unit) of a mobile relay node configured to migrate from the donor node to another donor node, a new establishment request for F1 connection for the other donor node, wherein
the F1 connection is established between a second DU of the mobile relay node and the other donor node.

5. The donor node according to claim 4, wherein
an F1 setup request message for requesting establishment of the F1 connection is configured to be transmitted to the other donor node in response to reception of the new establishment request at the second DU of the mobile relay node.

6. The donor node according to claim 4, wherein
the transceiver circuitry is configured to execute process of transmitting, to the first DU of the mobile relay node, a removal request of the F1 connection for the source donor node.

7. A mobile relay node in a cellular communication system, the mobile relay node comprising a first DU circuitry, a second DU circuitry, and a processing circuitry operatively associated with the first DU circuitry and second DU circuitry and configured to execute processing of:
receiving, at the first DU of the mobile relay node configured to migrate from a source donor node to a target donor node, a new establishment request for F1 connection for the target donor node transmitted from the source donor node, wherein
the F1 connection is established between the second DU circuitry of the mobile relay node and the target donor node.

8. The mobile relay node according to claim 7, further comprising:
transmitting, at the second DU circuitry, to the target donor node, an F1 setup request message for requesting establishment of the F1 connection in response to reception of the new establishment request.

9. The mobile relay node according to claim 7, wherein
the first DU circuitry is configured to execute process of receiving a removal request of the F1 connection for the source donor node from the source donor node.

10. A cellular communication system comprising:
a source donor node;
a target donor node; and
a mobile relay node, wherein
the source donor node is configured to transmit, to a first DU (Distributed Unit) of the mobile relay node configured to migrate from the source donor node to the target donor node, a new establishment request for F1 connection for the target donor node, and
the F1 connection is established between a second DU of the mobile relay node and the target donor node.

11. The cellular communication system according to claim 10, wherein
the second DU of the mobile relay node is configured to transmit, to the target donor node, an F1 setup request message for requesting establishment of the F1 connection in response to reception of the new establishment request.

12. The cellular communication system according to claim 10, wherein
the source donor node is configured to transmit, to the first DU of the mobile relay node, a removal request of the F1 connection for the source donor node.

13. A non-transitory computer-readable storage medium storing a program for causing a computer of a source donor node in a mobile communication system, to execute processing comprising:
transmitting, to a first DU (Distributed Unit) of a mobile relay node configured to migrate from the source donor node to a target donor node, a new establishment request for F1 connection for the target donor node, wherein
the F1 connection is established between a second DU of the mobile relay node and the target donor node.

14. The non-transitory computer-readable storage medium according to claim 13, wherein
an F1 setup request message for requesting establishment of the F1 connection is configured to be transmitted to the target donor node in response to reception of the new establishment request at the second DU of the mobile relay node.

15. The non-transitory computer-readable storage medium according to claim 13, further comprising:
transmitting, to the first DU of the mobile relay node, a removal request of the F1 connection for the source donor node.

16. A chipset for a source donor node, the chipset comprising:
transmitting, to a first DU of a mobile relay node configured to migrate from the source donor node to a target donor node, a new establishment request for F1 connection for the target donor node, wherein
the F1 connection is established between a second DU of the mobile relay node and the target donor node.

17. The chipset according to claim 16, wherein
an F1 setup request message for requesting establishment of the F1 connection is configured to be transmitted to the target donor node in response to reception of the new establishment request at the second DU of the mobile relay node.

18. The chipset according to claim 16, further comprising:
transmitting, to the first DU of the mobile relay node, a removal request of the F1 connection for the source donor node.
